(19) United States
(12) Patent Application Publication
(10) Pub. No.: US 2021/0027729 A1
(43) Pub. Date: Jan. 28, 2021

(54) DRIVING METHOD AND DRIVING DEVICE OF DISPLAY PANEL

(71) Applicant: HKC CORPORATION LIMITED, Shenzhen (CN)

(72) Inventor: Jianfeng SHAN, Shenzhen (CN)

(21) Appl. No.: 16/981,478

(22) PCT Filed: Feb. 26, 2019
(86) PCT No.: PCT/CN2019/076184

§ 371 Date: Sep. 16, 2020

(30) Foreign Application Priority Data
Jan. 30, 2019 (CN) 201910101644.2

(51) Int. Cl. G09G 3/36

(52) U.S. Cl. CPC G09G 3/3607; G09G 3/3614; G09G 2320/0242; G09G 3/3688; G09G 2310/0205; G09G 3/3677

(57) ABSTRACT

Disclosed are a driving method and a device of a display panel. The method includes: driving pixel units in the even-numbered column of a first row of pixel units by a first scanning driving signal, and driving pixel units in the even-numbered column of a second row of by a second scanning driving signal, in which the turned-on time duration for the pixel units of the first row is longer than the turned-on time duration for the pixel units of the second row. As such, the charging time duration is different for different pixel units, and high voltage pixel units and low voltage pixel units are alternately arranged, thereby improving color shift.

### CROSS REFERENCE TO RELATED APPLICATIONS

The present application is the National Stage of International Application No. PCT/CN2019/076184, filed on Feb. 26, 2019, which claims the priority of Chinese Patent Application filed in the National Intellectual Property Administration on Jan. 30, 2019, with the application number 201910101644.2 and Title “Driving method and driving device of display panel”, the entire contents of which are hereby incorporated by reference.

### TECHNICAL FIELD

The present application relates to the technical field of liquid crystal display, in particular to a driving method and a driving device of a display panel.

### BACKGROUND

The existed large-size liquid crystal display panel mostly use negative Vertical Alignment (VA) liquid crystals or In-Plane Switching (IPS) liquid crystals.

It has been found that VA liquid crystal technology has higher production efficiency and lower manufacturing cost, compared with IPS liquid crystal technology, but its performance in optical properties is inferior to IPS liquid crystal technology and has obvious optical property defects.

The defects happen especially when the large-sized display panels are applied. If the display panel is viewed at a relatively small viewing angle in the driving process of the VA liquid crystal, for example, in front view, the pixel brightness will linearly change with the voltage. An ideal curve is thus named after. If the display panel is viewed at a relatively larger viewing angle, the pixel brightness will rapidly saturate with the voltage, severely deteriorating the image quality in the viewing angle. An actual curve A1 with a single pixel is named after. Obviously, there is no little difference between the ideal curve and the actual curve, which makes a serious change in the gray scale that should have been presented in a larger viewing angle because of the deterioration, resulting in color shift.

In order to improve the color shift regarding VA liquid crystal, a general solution is to further divide subpixels into main pixels and sub-pixels. An actual curve A2 with the main and sub-pixels is integrated by a curve A representing the main pixels and a curve B representing the subpixels, which means that the subpixels are displayed through the main pixels and subpixels jointly. Obviously, the actual curve A2 obtained by dividing main and sub-pixels, is closer to the ideal curve than the actual curve A1. As such, the change trend in pixel brightness according to the voltage at a larger viewing angle is close to that at a smaller angle of view.

However, the manner that division of the main pixel and the sub-pixel will solve the color shift by spatially providing a difference in driving voltages to the main pixel and the sub-pixel, but may also bring about the requirement of redesigning the metal traces or Thin Film Transistor (TFT) elements to drive the sub-pixel. The transmitting opening area has to be sacrificed and the panel transmittance is further affected.

For above, it is believed that the current solution for improving the color shift may not be a perfect one because of its negative influence on panel transmittance.

The aforementioned is assistant in understanding the technical solution of the present application, and does not necessarily admit that the aforementioned constitutes the prior art.

### SUMMARY

The main purpose of the present application is to provide a driving method, and a driving device of a display panel, aiming at effectively improving the color shift without affecting the panel transmittance.

In order to achieve the above objective, the present application provides a driving method of a display panel. The display panel includes a display array including pixel units arranged in an array; the driving method includes:

taking a process of having scanned two adjacent rows of the pixel units as a driving period, driving the pixel units in an even-numbered column of a first row by a first scanning driving signal, and driving the pixel units in an even-numbered column of a second row by a second scanning driving signal, when four scanning driving signals respectively input by scanning driving lines in the driving period are received, in which a turn-on time for the pixel units of the first row by the first scanning driving signal is longer than a turn-on time for the pixel units of the second row by the second scanning driving signal;

driving the pixel units in an odd-numbered column of a first row by a third scanning driving signal, and driving the pixel units in an odd-numbered column of a second row by a fourth scanning driving signal, in which a turn-on time for the pixel units of the first row by the third scanning driving signal is shorter than a turn-on time for the pixel units of the second row by the fourth scanning driving signal; and

driving pixel units of the first row and the pixel units of the second row by the data driving signal, when each data driving signal input by a data driving line being received.

In addition, for above objective, the present application further provides a driving method of a display panel, in which the display panel includes a display array and a scanning driving line, the display array including pixel units arranged in an array, the scanning driving line including a main scanning driving line and a sub-scanning driving line, the pixel units including the pixel units of a first row and the pixel units of a second row, gates of the pixel units in the odd-numbered column of the first row are connected with the main scanning driving line for the first row; gates of the pixel units in the even-numbered column of the first row are connected with the sub-scanning driving line for a previous row relative to the pixel units of the first row, gates of pixel units in the odd-numbered column of the second row are connected with the main scanning driving line for the second row, and gates of pixel units in the even-numbered column of the second row are connected with the sub-scanning driving line for the first row; the driving method includes:

taking a process of having scanned two adjacent rows of the pixel units as a driving period, driving the pixel units in an even-numbered column of a first row by a first scanning driving signal through the sub-scanning driving line for a previous row relative to the pixel units of the first row, and driving the pixel units in an even-numbered column of a second row by a second scanning driving signal through the sub-scanning driving line for the first row, in which a turn-on time for the pixel units of the first row by the first scanning driving signal is longer than a turn-on time for the pixel units of the second row by the second scanning driving signal, when four scanning driving signals respectively input by scanning driving lines in the driving period are received;

driving the pixel units in an odd-numbered column of a first row by a third scanning driving signal through the main scanning driving line for the first row, and driving the pixel units in an odd-numbered column of a second row by a fourth scanning driving signal through the main scanning driving line for the second row, in which a turn-on time for the pixel units of the first row by the third scanning driving signal is different from a turn-on time for the pixel units of the second row by the fourth scanning driving signal;

driving pixel units of the first row and the pixel units of the second row by the data driving signal, when each data driving signal input by a data driving line being received.

In addition, for above objective, the present application further provides a driving device for a display panel, in which the display panel includes a display array including pixel units arranged in an array; the driving device includes:

a driving module, configured to take having scanned two adjacent rows of the pixel units as a driving period, drive the pixel units in an even-numbered column of a first row by a first scanning driving signal, and drive the pixel units in an even-numbered column of a second row by a second scanning driving signal, when four scanning driving signals respectively input by scanning driving lines in the driving period are received, in which a turn-on time for the pixel units of the first row by the first scanning driving signal is longer than a turn-on time for the pixel units of the second row by the second scanning driving signal.

The driving module is further configured to drive the odd-numbered column pixel units of the pixel units of the first row with a third scanning driving signal and drive the odd-numbered column pixel units of the pixel units of the second row with a fourth scanning driving signal, in which the turned-on time duration for the third scanning driving signal to drive the pixel units to realize conduction is smaller than the turned-on time duration for the fourth scanning driving signal to drive the pixel units to realize conduction.

The drive module is further configured to drive pixel units of the first row and the pixel units of the second row by the data driving signal, when each data driving signal input by a data driving line is received.

In addition, for above objective, the present application further provides a display apparatus, which includes: a display panel, a memory, a processor, and driving programs of the display panel stored on the memory and operable on the processor. The display panel includes a display array including pixel units arranged in an array. The driving program of the display panel implement the operations of the driving method of the display panel as described above.

In order to effectively avoid the color shift without redesigning the metal traces or TFT elements, the pixel units are driven by two different scanning driving signals in the row direction in the present application. Because the turn-on time is different between two scanning driving signals that turn on the pixel units, the difference in charging time for the pixel units by the data driving signals is indirectly controlled. The different charging capabilities brings about the alternative arrangement of the high-voltage pixel units and the low-voltage pixel units, thereby improving the color shift. For above, it is believed that the present application successfully improves the color shift without affecting the panel transmittance.

### BRIEF DESCRIPTION OF THE DRAWINGS

FIG. 1 is a schematic diagram of a display device illustrating a hardware operating environment according to some embodiments of the present application;

FIG. 2 is a schematic flow chart illustrating a driving method of a display panel in some embodiments according to the present application;

FIG. 3 is a first structural diagram showing a display array;

FIG. 4 is a schematic diagram of a first driving time sequence of the display array;

FIG. 5 is a structural schematic diagram of a driving device of a display panel in some embodiments according to the present application;

FIG. 6 is a structural schematic diagram of a driving device of a display panel in some other embodiments according to the present application.

The implementation, functional characteristics and advantages of the present application will be further described with reference to the attached drawings in combination with embodiments.

### DETAILED DESCRIPTION OF THE EMBODIMENTS

It should be understood that the specific embodiments described herein are only for illustrative purpose and are not intended to limit the present application.

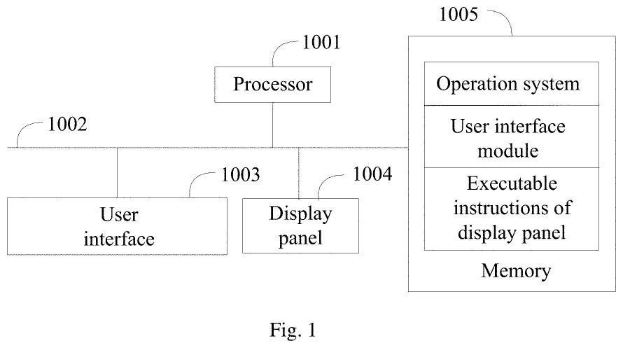

Referring to FIG. 1, which is a schematic structural diagram of a display device illustrating a hardware operating environment according to an embodiment of the present application.

As shown in FIG. 1, the display device may include a processor 1001, such as a CPU, a communication bus 1002, a user interface 1003, a display panel 1004, and a memory 1005. In which, the communication bus 1002 is configured to implement connection and communication between these components. The user interface 1003 may include a display, an input unit such as a keyboard, and the optional user interface 1003 may further include a standard wired interface and a wireless interface. The memory 1005 may be a high-speed RAM memory or a non-volatile memory such as a disk memory. The memory 1005 may alternatively be a storage device independent of the aforementioned processor 1001.

As shown in FIG. 1, the memory 1005 as a storage medium may include an operating system, a user interface module and driving program for a display panel.

In the display device shown in FIG. 1, the user interface 1003 is mainly configured to connect a user terminal and perform data communication with the terminal. The processor 1001 and the memory 1005 in the display device of the present application may be provided in a data driving integrated circuit, which calls a driver of the display panel stored in the memory 1005 through the processor 1001 and executes an operation of a driving method of the display panel.

Based on the above hardware structure, the display panel includes a display array including pixel units arranged in an array, and embodiments of the driving method of the display panel of the present application are proposed.

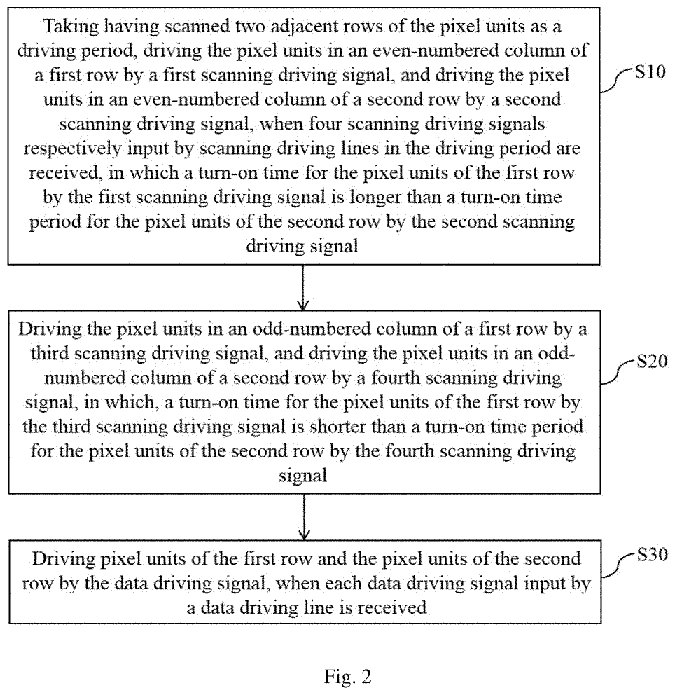

Referring to FIG. 2, which is a schematic flow chart regarding a driving method of a display panel in some embodiments according to the present application.

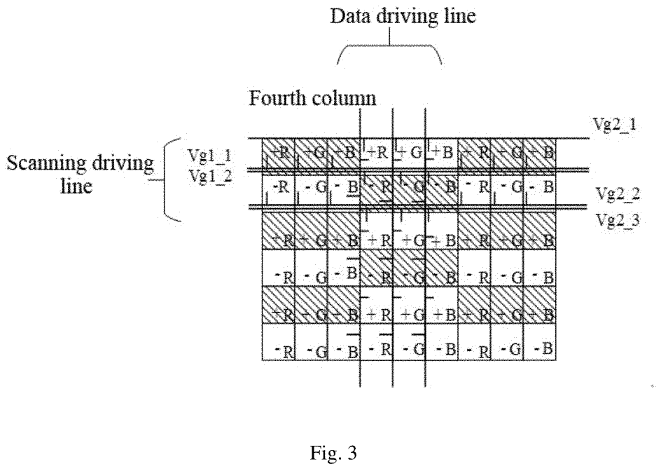

The display array can be seen in FIG. 3.

In some embodiments, the driving method of the display panel includes:

Step S10, taking a process of having scanned two adjacent rows of the pixel units as a driving period, driving the pixel units in an even-numbered column of a first row by a first scanning driving signal, and driving the pixel units in an even-numbered column of a second row by a second scanning driving signal, when four scanning driving signals respectively input by scanning driving lines in the driving period are received, in which a turn-on time for the pixel units of the first row by the first scanning driving signal is longer than a turn-on time for the pixel units of the second row by the second scanning driving signal.

In real practice, these embodiments may be implemented based on the display array shown in FIG. 3. Specifically, the data driving signals used for the pixel units of the first row and the pixel units of the second row may be the same, but there will be differences in the four scanning driving signals input by the scanning driving lines.

Step S20, driving the pixel units in an odd-numbered column of a first row by a third scanning driving signal, and driving the pixel units in an odd-numbered column of a second row by a fourth scanning driving signal, in which, a turn-on time for the pixel units of the first row by the third scanning driving signal is shorter than a turn-on time for the pixel units of the second row by the fourth scanning driving signal; and

It should be understood that the embodiments can drive the pixel units in the odd-numbered column and the pixel units in the even-numbered column differently, providing different scanning driving signals for the pixel units in the odd-numbered column and the pixel units in the even-numbered column respectively.

Step S30, driving pixel units of the first row and the pixel units of the second row by the data driving signal, when each data driving signal input by a data driving line being received.

It can be understood that since the scanning driving signal is configured to control on and off of the pixel units, the data driving signal is configured to charge the pixel units, but the premise for the data driving signal to charge the pixel units is that the pixel unit to be controlled turned-on by the scanning driving signal. Therefore, when the data driving signals are the same but the scanning driving signals are different, the longer the pixel unit is turned on by the scanning driving signals, the longer the charging time that the pixel unit can be charged by the data driving signals.

In real practice, in some embodiments, since the turned-on time duration for the first scanning driving signal to drive the in the even-numbered column of the first row is longer than that for the second scanning driving signal to drive the pixel units in the even-numbered column of the second row, indicating a difference between the turned-on time durations of the two. Therefore, regarding the pixel units in the even-numbered column, the actual driving time T1 for the pixel units of the first row is greater than the driving time T1′ for the pixel units of the second row. And the charging time of the pixel units in the even-numbered column of the second row is relatively smaller, thus reducing the equivalent charging voltage for the pixel units in the even-numbered column of the second row, forming the so-called low voltage pixel units. Correspondingly, the equivalent charging voltage for the pixel units in the even-numbered column of the pixel units of the first row is relatively larger, forming a so-called high voltage pixel units. Thus it is distinguishing the charging of high voltage pixel units from the charging of low voltage pixel units.

It should be understood that it is precisely because the charging between the high voltage pixel units and the low voltage pixel units are distinguished, that the upper limit of the chargeable duration of the pixel units in the even-numbered column of the first row can be made larger and the charging capability is relatively better, so that the upper limit of the chargeable duration of the pixel units in the even-numbered column of the pixel units of the second row is smaller and the charging capability is relatively worse, thus making the difference in charging between the high voltage pixel units and the low voltage pixel units. As such, alternatively arrangement of the high voltage and low voltage pixel units are formed, thereby improving the color shift. Similarly, regarding the pixel units in odd-numbered column, the turn-on time for the third scanning driving signal to drive the pixel units is shorter than the turn-on time for the fourth scanning driving signal to drive the pixel units, thus making the difference in charging between the high voltage pixel units and the low voltage pixel units.

In order to effectively avoid the color shift without redesigning the metal traces or TFT elements, the pixel units are driven by two different scanning driving signals in the row direction in the present application. Because the turn-on time is different between two scanning driving signals that turn on the pixel units, the difference in charging time for the pixel units by the data driving signals is indirectly controlled. The different charging capabilities brings about the alternative arrangement of the high-voltage pixel units and the low-voltage pixel units, thereby improving the color shift. For above, it is believed that the embodiments successfully improves the color shift without affecting the panel transmittance.

Further, the scanning driving line includes a main scanning driving line and a sub-scanning driving line; gates of the pixel units in the odd-numbered column of the first row are connected with the main scanning driving line for the first row; gates of the pixel units in the even-numbered column of the first row are connected with the sub-scanning driving line for a previous row relative to the pixel units of the first row, gates of pixel units in the odd-numbered column of the second row are connected with the main scanning driving line for the second row, and gates of pixel units in the even-numbered column of the second row are connected with the sub-scanning driving line for the first row.

The operation of taking a process of having scanned two adjacent rows of the pixel units as a driving period, driving the pixel units in an even-numbered column of a first row by a first scanning driving signal, and driving the pixel units in an even-numbered column of a second row by a second scanning driving signal, when four scanning driving signals respectively input by scanning driving lines in the driving period are received, includes:

taking a process of having scanned two adjacent rows of the pixel units as a driving period, driving the pixel units in an even-numbered column of a first row by a first scanning driving signal through the sub-scanning driving line of the previous row relative to the pixel units of the first row, and driving the pixel units in an even-numbered column of a second row by a second scanning driving signal through the sub-scanning driving line for the first row, when four scanning driving signals respectively input by scanning driving lines in the driving period are received.

The operation of driving the pixel units in an odd-numbered column of a first row by a third scanning driving signal, and driving the pixel units in an odd-numbered column of a second row by a fourth scanning driving signal, includes:

driving the pixel units in an odd-numbered column of a first row by a third scanning driving signal through the main scanning driving line for the first row, and driving the pixel units in an odd-numbered column of a second row by a fourth scanning driving signal through the main scanning driving line for the second row.

It can be understood that in order to implement the structure of alternative arrangement of the high voltage pixel units and the low voltage pixel units, the embodiments provide a specific scanning driving line, which can be seen in FIG. 3. As can be seen from FIG. 3, in order to provide the first scanning driving signal for the pixel units of the first row and the second scanning driving signal for the pixel units of the second row, the embodiments may simultaneously deploy two scanning driving lines for each row of pixel units. For example, the pixel units of the first row will have the first row of main scanning driving lines and the sub-scanning driving lines, the output signals of which are Vg1_1 and Vg1_2 respectively. The pixel units of the second row will have the main scanning driving line and the sub-scanning driving line, and their output signals are Vg2_2 and Vg2_3, respectively. In addition, the pixel units in FIG. 3 consists of three subpixels.

In real practice, referring to FIG. 3, in which the display array is arranged in an order of 6*3, with a total of 18 pixel units. In order to provide scanning driving signals for the pixel units of the entire first row as well as for the pixel units of the entire second row, specifically, regarding for the first row, the second pixel unit in the first row in FIG. 3 is in the even-numbered column of the second column, which would be driven by the sub-scanning driving lines for the previous row relative to the first row, referred to as the first scanning driving line Vg2_1. The first pixel unit of the first row is in the odd-numbered column, and will be driven by the output signal Vg1_1 of the main scanning driving line for the first row, being referred as the third scanning driving signal. Regarding for the second row, the second pixel unit of the second row in FIG. 3 is in the even-numbered column of the second column, which would be driven by the sub-scanning driving lines Vg1_2 for the first row, referred to as the second scanning driving line Vg1_2. The first pixel unit of the second row is in the odd-numbered column, and will be driven by the output signal Vg2_2 of the main scanning driving line for the second row, being referred as the fourth scanning driving signal. In which, the first scanning driving signal is Vg2_1, the second scanning driving signal is Vg1_2, the third scanning driving signal is Vg1_1, and the fourth scanning driving signal is Vg2_2.

It can be understood that referring to FIG. 3, regarding the pixel units in the first column, the first pixel unit in the first column will be driven by the third scanning driving signal, and the second pixel unit of the first column will be driven by the fourth scanning driving signal. Because the turned-on time duration for the third scanning driving signal to conduct the pixel units is different from the turned-on time duration for the fourth scanning driving signal to conduct the pixel units, for example, the turn-on time for the third scanning driving signal to conduct the pixel unit is smaller than the turn-on time for the fourth scanning driving signal to conduct the pixel unit, which will form the difference in charging between the first pixel unit in the first column and the second pixel unit in the first column, and further form the difference between the high voltage pixel unit and the low voltage pixel unit. Regarding the pixel units in the second column, the first pixel unit in the second column will be driven by the first scanning driving signal, and the second pixel unit of the second column will be driven by the second scanning driving signal. Because the turned-on time duration for the first scanning driving signal to conduct the pixel units is different from the turned-on time duration for the second scanning driving signal to conduct the pixel units, for example, the turn-on time for the first scanning driving signal to conduct the pixel unit is longer than the turn-on time for the second scanning driving signal to conduct the pixel unit, which will form the difference in charging between the first pixel unit in the second column and the second pixel unit in the second column, and further form the difference between the high voltage pixel unit and the low voltage pixel unit.

Obviously, by the arrangement of the main and sub-scanning driving lines, high voltage pixel units and low voltage pixel units can be formed and arranged alternately, thus improving color shift.

Further, the pixel units consist of subpixels; the data driving lines includes a data driving line for the odd-numbered column and a data driving line for the even-numbered column; the sources of the pixel units in the odd-numbered column of the first row are respectively connected with the corresponding data driving line for the odd-numbered column, the sources of the pixel units in the even-numbered column of the first row are respectively connected with the corresponding data driving line for the even-numbered column; the sources of the pixel units in the odd-numbered column of the second row are respectively connected with a next data driving line for the even-numbered column adjacent to the data driving line for the corresponding odd-numbered column, and the sources of the pixel units in the even-numbered column of the second row are respectively connected with a next data driving line for the odd-numbered column adjacent to the data driving line for the corresponding even-numbered column.

The operation of driving pixel units of the first row and the pixel units of the second row by the data driving signal, when each data driving signal input by a data driving line being received, includes:

driving the subpixels in the odd-numbered column of the first row by the data driving line for the odd-numbered column, driving the subpixels in the even-numbered column of the first row by the data driving line for the even-numbered column, driving the subpixels in the odd-numbered column of the second row by the next data driving line for the even-numbered column adjacent to the data driving line for the odd-numbered column, and driving the subpixels in the even-numbered column of the second row by the next data driving line for the odd-numbered column adjacent to the data driving line for the even-numbered column, when each data driving signal input by a data driving line being received.

It can be understood that in order to realize data driving for pixel units, the embodiments provide specific data driving lines, which can be seen in FIG. 3. In FIG. 3, data driving lines are respectively drawn for columns 4, 5 and 6. For example, in FIG. 3, the fifth subpixel of the first row belongs to the fifth column which is the odd-numbered column, and would be driven by the data driving signal output by the data driving line for the fifth column. However, the fifth subpixel of the second row will be driven by the data driving line for the even-numbered column adjacent to the data driving line for the fifth column, that is, by the data driving line for the sixth column. Obviously, the subpixels in the same column are not driven by a same data driving line. Similarly, the sixth subpixel of the second row in FIG. 3 belongs to the sixth column which is the even-numbered column, and would be driven by the data driving signal output by the data driving line for the sixth column. However, the sixth subpixel of the second row will be driven by the data driving line for the odd-numbered column adjacent to the data driving line for the sixth column, that is, by the data driving line for the seventh column. In FIG. 3, the data driving line for the seventh column is omitted.

Further, the operation of driving pixel units of the first row and the pixel units of the second row by the data driving signal, when each data driving signal input by a data driving line being received, includes:

positively driving the pixel units of the first row and the second row by a first preset voltage, when each data driving signal input by a data driving line being received and the data driving signal is in a first half of a data driving period, in which the data driving period is a signal period of the data driving signal, and the first preset voltage is greater than a reference voltage;

negatively driving the pixel units of the first row and the second row by a second preset voltage, when the data driving signal is in a second half of the data driving period, the first preset voltage being smaller than the reference voltage.

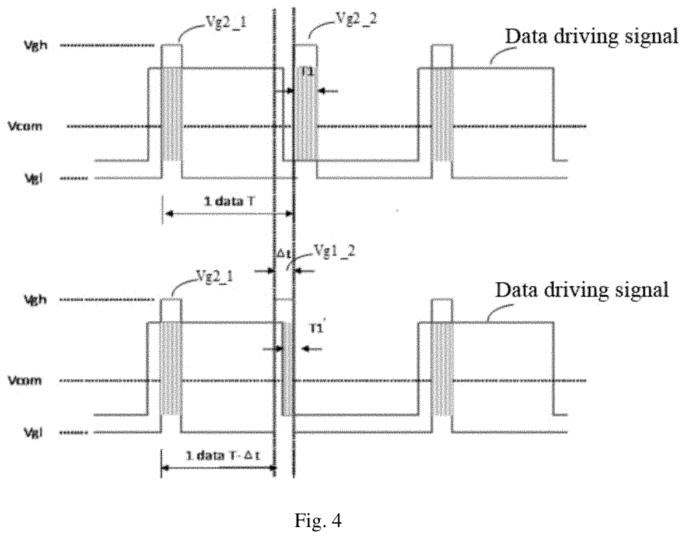

In real practice, FIG. 4 can be referred. The data driving signal in some embodiments will have a first preset voltage larger than the reference voltage Vcom and a second preset voltage smaller than the reference voltage Vcom in a complete data driving period. By setting the first preset voltage and the second preset voltage alternatively, positive driving and negative driving can be alternately performed, thus realizing polarity inversion of liquid crystal molecules and preventing a damage of the liquid crystal molecules characteristics.

Further, the operation of taking a process of having scanned two adjacent rows of the pixel units as a driving period, driving the pixel units in an even-numbered column of a first row by a first scanning driving signal, and driving the pixel units in an even-numbered column of a second row by a second scanning driving signal, when four scanning driving signals respectively input by scanning driving lines in the driving period are received, includes:

taking a process of having scanned two adjacent rows of the pixel units as a driving period, driving the pixel units in the even-numbered column of the first row by a first scanning driving signal, to turn on the pixel units of the first row for a first pulse duration, when four scanning driving signals respectively input by scanning driving lines in the driving period are received, in which a starting time and an ending time of the first pulse duration are within the first half of the data driving period;

driving the pixel units in the even-numbered column of the second row by a second scanning driving signal, to turn on the pixel units of the second row for a second pulse duration, in which a starting time of the second pulse duration is within the first half of the data driving period while an ending time of the second pulse duration is within the second half of the data driving period.

It can be understood that the specific arrangement of the scanning driving signal can be seen in FIG. 4, in which the drive time sequence is recorded of the display array shown in FIG. 3. As far as FIG. 4 is concerned, in order to facilitate comparison between signals, the first scanning driving signal Vg2_1 and the fourth scanning driving signal Vg2_2 are plotted together in FIG. 4, which is the upper diagram in FIG. 4. And the first scanning driving signal Vg2_1 and the second scanning driving signal Vg1_2 are plotted together, which is the lower diagram in FIG. 4. Where Vgh is the maximum value of the scanning driving signal and Vg1 is the minimum value of the scanning driving signal.

In real practice, the scanning driving period of each scanning driving signal can be recorded as 1dataT. The time duration of the data driving period is 2*dataT, and the first half of the data driving period and the second half of the data driving period of the 2*dataT are both dataT.

It should be understood that, obviously, in FIG. 4, the first scanning driving signal Vg2_1 will generate a pulse duration, and the starting and ending point of the pulse duration will both occur in the first half of the data driving period, so positive driving will be completely implemented with a driving duration of T1. While in the lower diagram of FIG. 4, the second scanning driving signal Vg1_2 will also generate a pulse duration. However, with the time sequence of the data driving signal as a reference, the starting time of the pulse duration occurs in the first half of the data driving period but the ending time falls in the second half of the data driving period. In other words, the starting time of the pulse duration will be 1dataT−Δt, rather than 1dataT, which means it starts early by Δt.

Understandably, just precisely because the second pulse duration occurs at 1dataT−Δt, the second pulse duration just includes the jump time when the data driving signal jumps from the first preset voltage to the second preset voltage, the driving time period during which the data driving signal can be driven negatively is shortened, and the driving time period is reduced to T1′, which is naturally smaller than the original pulse duration T1.

It should be understood that the turn-on time T1′ of the second scanning driving signal which turns on the pixel unit is smaller than the turn-on time T1 of the first scanning driving signal which turns on the pixel unit, thus bringing about the charging difference and thus the high voltage pixel unit and the low voltage pixel unit.

In addition, the shaded portion in FIG. 4 is a period during which the scanning driving signal turns on the pixel unit so that the pixel unit can be charged by the data driving signal.

In addition, similarly, it should be understood that the turn-on time T1′ of the third scanning driving signal which turns on the pixel unit is smaller than the turn-on time T1 of the fourth scanning driving signal which turns on the pixel unit, thus bringing about the charging difference and thus the high voltage pixel unit and the low voltage pixel unit.

Further, the pixel unit includes a first subpixel, a second subpixel and a third subpixel in a row direction, and the three subpixels of each pixel unit are respectively aligned in columns according to an arranging order;

The first subpixel, the second subpixel and the third subpixel respectively correspond to a red subpixel, a green subpixel and a blue subpixel.

In real practice, FIG. 3 can be referred to. In which the pixel unit consists of three subpixels with three colors. For example, a red subpixel denoted by R, a green subpixel denoted by G, and a blue subpixel denoted by B.

Further, polarity of the pixel units between the first row and the second row are opposite.

In real practice, polarity inversion can be performed based on row inversion. For example, referring to FIG. 3, the pixel units of the first row are driven positively and the pixel units of the second row are driven negatively. In which, VGd_1 is a subpixel in a pixel unit of the first row and VGd_2 is a subpixel in a pixel unit of the second row.

It should be understood that, unlike forming high voltage pixels and low voltage pixels by dot inversion with the same scanning driving signals in each row, the increase in the number of subpixels in the same row increases the driving frequency, which increases the loading on the integrated circuit (IC), and risks increasing the temperature of driving the IC. Different from the above solution, the difference in high voltage pixels and low voltage pixels will be formed based on row arrangement and different scanning driving signals in some embodiments, which would have no defect of resolution reduction.

Further, the pixel units of the first row are pixel units of the odd-numbered row and the pixel units of the second row are pixel units of the even-numbered row; or, the pixel units of the first row are pixel units of the even-numbered row and the pixel units of the second row are pixel units of the odd-numbered row.

Based on the above hardware structure, the display panel includes a display array including pixel units arranged in an array. In which, the driving time sequence of the display array can also be changed, in order to inverse the scanning driving signals for two rows of pixel units. The charging time of the data driving signal is switched correctly by the gate, so that the actual charging signal of the data driving signal to the pixel units of the first row is shorter, and the actual charging signal of the data driving signal to the pixel units of the second row is longer, so as to form pixel units with different high and low voltages. Moreover, the difference between the high and low voltage subpixels cannot be obviously distinguished by naked eyes, and no resolution reduction would be caused.

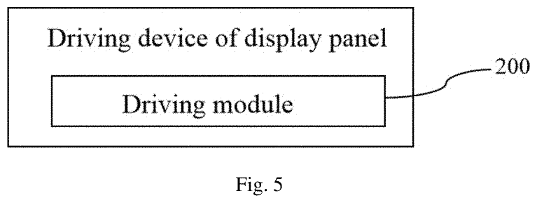

In addition, the embodiments of the present application also provide a driving device of the display panel. As shown in FIG. 5, the display panel includes a display array which includes pixels arranged in an array. The driving device includes:

a driving module 200, which is configured to take having scanned two adjacent rows of the pixel units as a driving period, drive the pixel units in an even-numbered column of a first row by a first scanning driving signal, and drive the pixel units in an even-numbered column of a second row by a second scanning driving signal, when four scanning driving signals respectively input by scanning driving lines in the driving period are received, in which a turn-on time for the pixel units of the first row by the first scanning driving signal is longer than a turn-on time for the pixel units of the second row by the second scanning driving signal.

The driving module 200, is further configured to drive the pixel units in an odd-numbered column of a first row by a third scanning driving signal, and drive the pixel units in an odd-numbered column of a second row by a fourth scanning driving signal, in which a turn-on time for the pixel units of the first row by the third scanning driving signal is shorter than a turn-on time for the pixel units of the second row by the fourth scanning driving signal.

The drive module 200, is further configured to drive pixel units of the first row and the pixel units of the second row by the data driving signal, when each data driving signal input by a data driving line is received.

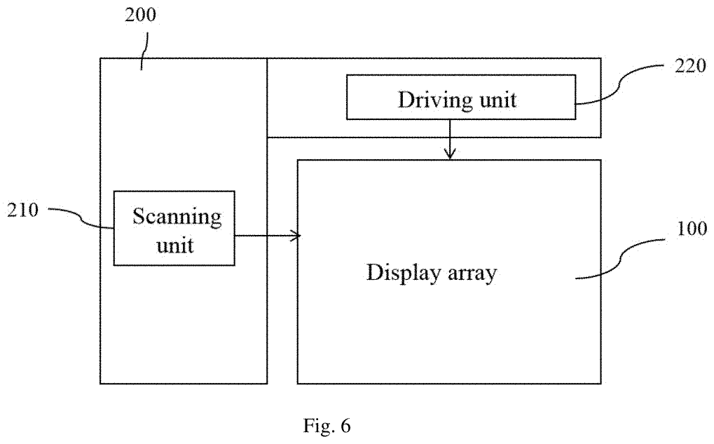

As shown in FIG. 6, the driving device of the display panel further includes a display array 100 and a driving module 200. The driving module 200 may include a scanning unit 210 and a driving unit 220. The scanning unit 210 is configured to output the scanning driving signals, to generally scan the pixel units line by line, and the driving unit 220 is configured to output the data driving signals to enable the pixel units to receive driving data for display when being scanned.

The driving module can be referred to the embodiments aforementioned. After the processing, the pixel units are driven by two different scanning drive signals in the row direction in the present application. Because the turn-on time is different between two scanning driving signals that turn on the pixel units, the difference in charging time for the pixel units by the data driving signals is indirectly controlled. The different charging capabilities brings about the alternative arrangement of the high-voltage pixel units and the low-voltage pixel units, thereby improving the color shift. For above, it is believed that the present application successfully improves the color shift without affecting the panel transmittance.

In addition, the embodiments of the present application also provide a storage medium on which the driving program of the display panel is stored, and the driving program of the display panel is executed by a processor as described above.

1. A driving method of a display panel, wherein
the display panel comprises a display array comprising pixel units arranged in an array;
the driving method comprises:
taking a process of having scanned two adjacent rows of the pixel units as a driving period, driving the pixel units in an even-numbered column of a first row by a first scanning driving signal, and driving the pixel units in an even-numbered column of a second row by a second scanning driving signal, when four scanning driving signals respectively input by scanning driving lines in the driving period being received, wherein a turn-on time for the pixel units of the first row by the first scanning driving signal is longer than a turn-on time for the pixel units of the second row by the second scanning driving signal;
driving the pixel units in an odd-numbered column of a first row by a third scanning driving signal, and driving the pixel units in an odd-numbered column of a second row by a fourth scanning driving signal, wherein a turn-on time for the pixel units of the first row by the third scanning driving signal is shorter than a turn-on time for the pixel units of the second row by the fourth scanning driving signal; and
driving pixel units of the first row and the pixel units of the second row by the data driving signal, when each data driving signal input by a data driving line being received.

2. The driving method of claim 1, wherein the scanning driving line comprises a main scanning driving line and a sub-scanning driving line; gates of the pixel units in the odd-numbered column of the first row are connected with the main scanning driving line for the first row; gates of the pixel units in the even-numbered column of the first row are connected with the sub-scanning driving line for a previous row relative to the pixel units of the first row, gates of pixel units in the odd-numbered column of the second row are connected with the main scanning driving line for the second row, and gates of pixel units in the even-numbered column of the second row are connected with the sub-scanning driving line for the first row;
the operation of taking a process of having scanned two adjacent rows of the pixel units as a driving period, driving the pixel units in an even-numbered column of a first row by a first scanning driving signal, and driving the pixel units in an even-numbered column of a second row by a second scanning driving signal, when four scanning driving signals respectively input by scanning driving lines in the driving period being received, comprises:
taking a process of having scanned two adjacent rows of the pixel units as a driving period, driving the pixel units in an even-numbered column of a first row by a first scanning driving signal through the sub-scanning driving line of the previous row relative to the pixel units of the first row, and driving the pixel units in an even-numbered column of a second row by a second scanning driving signal through the sub-scanning driving line for the first row, when four scanning driving signals respectively input by scanning driving lines in the driving period are received;
the operation of driving the pixel units in an odd-numbered column of a first row by a third scanning driving signal, and driving the pixel units in an odd-numbered column of a second row by a fourth scanning driving signal, comprises:
driving the pixel units in an odd-numbered column of a first row by a third scanning driving signal through the main scanning driving line for the first row, and driving the pixel units in an odd-numbered column of a second row by a fourth scanning driving signal through the main scanning driving line for the second row.

3. The driving method of claim 2, wherein
the pixel units consist of subpixels;
the data driving lines comprises a data driving line for the odd-numbered column and a data driving line for the even-numbered column;
sources of the pixel units in the odd-numbered column of the first row are respectively connected with the corresponding data driving line for the odd-numbered column, sources of the pixel units in the even-numbered column of the first row are respectively connected with the corresponding data driving line for the even-numbered column;
sources of the pixel units in the odd-numbered column of the second row are respectively connected with a next data driving line for the even-numbered column adjacent to the data driving line for the corresponding odd-numbered column, and sources of the pixel units in the even-numbered column of the second row are respectively connected with a next data driving line for the odd-numbered column adjacent to the data driving line for the corresponding even-numbered column;
the operation of driving pixel units of the first row and the pixel units of the second row by the data driving signal, when each data driving signal input by a data driving line being received, comprises:
driving the subpixels in the odd-numbered column of the first row by the data driving line for the odd-numbered column, driving the subpixels in the even-numbered column of the first row by the data driving line for the even-numbered column, driving the subpixels in the odd-numbered column of the second row by the next data driving line for the even-numbered column adjacent to the data driving line for the odd-numbered column, and driving the subpixels in the even-numbered column of the second row by the next data driving line for the odd-numbered column adjacent to the data driving line for the even-numbered column, when each data driving signal input by a data driving line being received.

4. The driving method of claim 1, wherein the operation of receiving each data driving signal input by a data driving line to drive pixel units of the first row and the pixel units of the second row, comprises:
positively driving the pixel units of the first row and the second row by a first preset voltage, when each data driving signal input by the data driving line being received and the data driving signal is in a first half of a data driving period, wherein the data driving period is a signal period of the data driving signal, and the first preset voltage is greater than a reference voltage; and
negatively driving the pixel units of the first row and the second row by a second preset voltage, when the data driving signal is in a second half of the data driving period, the first preset voltage being smaller than the reference voltage.

5. The driving method of claim 4, wherein the operation of taking a process of having scanned two adjacent rows of the pixel units as a driving period, driving the pixel units in an even-numbered column of a first row by a first scanning driving signal, and driving the pixel units in an even-numbered column of a second row by a second scanning driving signal, when four scanning driving signals respectively input by scanning driving lines in the driving period being received, comprises:
taking a process of having scanned two adjacent rows of the pixel units as a driving period, driving the pixel units in the even-numbered column of the first row by a first scanning driving signal, to turn on the pixel units of the first row for a first pulse duration, when four scanning driving signals respectively input by scanning driving lines in the driving period are received, wherein a starting time and an ending time of the first pulse duration are within the first half of the data driving period; and
driving the pixel units in the even-numbered column of the second row by a second scanning driving signal, to turn on the pixel units of the second row for a second pulse duration, wherein a starting time of the second pulse duration is within the first half of the data driving period while an ending time of the second pulse duration is within the second half of the data driving period.

6. The driving method of claim 1, wherein the pixel unit comprises a first subpixel, a second subpixel and a third subpixel in a row direction, and the three subpixels of each pixel unit are aligned in columns according to an arranging order;
the first subpixel, the second subpixel and the third subpixel respectively correspond to a red subpixel, a green subpixel and a blue subpixel.

7. The driving method of claim 1, wherein polarity of the pixel units between the first row and the second row are opposite.

8. The driving method of claim 7, wherein the pixel units of the first row are inverted in polarity relative to the pixel units of the second row by row inversion.

9. The driving method of claim 7, wherein the pixel units of the first row are inverted in polarity relative to the pixel units of the second row by dot inversion.

10. The driving method of claim 1, wherein the pixel units of the first row are pixel units of the odd-numbered row and the pixel units of the second row are pixel units of the even-numbered row; or,
the pixel units of the first row are pixel units of the even-numbered row and the pixel units of the second row are pixel units of the odd-numbered row.

11. A driving method of a display panel, wherein
the display panel comprises a display array and a scanning driving line, the display array comprising pixel units arranged in an array, the scanning driving line comprising a main scanning driving line and a sub-scanning driving line, the pixel units comprising the pixel units of a first row and the pixel units of a second row;
gates of the pixel units in the odd-numbered column of the first row are connected with the main scanning driving line for the first row; gates of the pixel units in the even-numbered column of the first row are connected with the sub-scanning driving line for a previous row relative to the pixel units of the first row, gates of pixel units in the odd-numbered column of the second row are connected with the main scanning driving line for the second row, and gates of pixel units in the even-numbered column of the second row are connected with the sub-scanning driving line for the first row;
the driving method comprises:
taking a process of having scanned two adjacent rows of the pixel units as a driving period, driving the pixel units in an even-numbered column of a first row by a first scanning driving signal through the sub-scanning driving line for a previous row relative to the pixel units of the first row, and driving the pixel units in an even-numbered column of a second row by a second scanning driving signal through the sub-scanning driving line for the first row, wherein a turn-on time for the pixel units of the first row by the first scanning driving signal is longer than a turn-on time for the pixel units of the second row by the second scanning driving signal, when four scanning driving signals respectively input by scanning driving lines in the driving period are received;
driving the pixel units in an odd-numbered column of a first row by a third scanning driving signal through the main scanning driving line for the first row, and driving the pixel units in an odd-numbered column of a second row by a fourth scanning driving signal through the main scanning driving line for the second row, wherein a turn-on time for the pixel units of the first row by the third scanning driving signal is different from a turn-on time for the pixel units of the second row by the fourth scanning driving signal; and
driving pixel units of the first row and the pixel units of the second row by the data driving signal, when each data driving signal input by a data driving line being received.

12. A driving device for a display panel, wherein
the display panel comprises a display array including pixel units arranged in an array;
the driving device comprises:
a driver, configured to take having scanned two adjacent rows of the pixel units as a driving period, drive the pixel units in an even-numbered column of a first row by a first scanning driving signal, and drive the pixel units in an even-numbered column of a second row by a second scanning driving signal, when four scanning driving signals respectively input by scanning driving lines in the driving period are received, wherein a turn-on time for the pixel units of the first row by the first scanning driving signal is longer than a turn-on time for the pixel units of the second row by the second scanning driving signal;
the driver, is further configured to drive the pixel units in an odd-numbered column of a first row by a third scanning driving signal, and drive the pixel units in an odd-numbered column of a second row by a fourth scanning driving signal, wherein a turn-on time for the pixel units of the first row by the third scanning driving signal is shorter than a turn-on time for the pixel units of the second row by the fourth scanning driving signal; and
the driver is further configured to drive pixel units of the first row and the pixel units of the second row by the data driving signal, when each data driving signal input by a data driving line being received.

13. The driving device of claim 12, wherein the scanning driving line comprises a main scanning driving line and a sub-scanning driving line; gates of the pixel units in the odd-numbered column of the first row are connected with the main scanning driving line for the first row; gates of the pixel units in the even-numbered column of the first row are connected with the sub-scanning driving line for a previous row relative to the pixel units of the first row, gates of pixel units in the odd-numbered column of the second row are connected with the main scanning driving line for the second row, and gates of pixel units in the even-numbered column of the second row are connected with the sub-scanning driving line for the first row;
the operation of taking a process of having scanned two adjacent rows of the pixel units as a driving period, driving the pixel units in an even-numbered column of a first row by a first scanning driving signal, and driving the pixel units in an even-numbered column of a second row by a second scanning driving signal, when four scanning driving signals respectively input by scanning driving lines in the driving period are received, comprises:
taking a process of having scanned two adjacent rows of the pixel units as a driving period, driving the pixel units in an even-numbered column of a first row by a first scanning driving signal through the sub-scanning driving line of the previous row relative to the pixel units of the first row, and driving the pixel units in an even-numbered column of a second row by a second scanning driving signal through the sub-scanning driving line for the first row, when four scanning driving signals respectively input by scanning driving lines in the driving period are received;
the operation of driving the pixel units in an odd-numbered column of a first row by a third scanning driving signal, and driving the pixel units in an odd-numbered column of a second row by a fourth scanning driving signal, comprises:
driving the pixel units in an odd-numbered column of a first row by a third scanning driving signal through the main scanning driving line for the first row, and driving the pixel units in an odd-numbered column of a second row by a fourth scanning driving signal through the main scanning driving line for the second row.

14. The driving device of claim 13, wherein the pixel units consist of subpixels;
the data driving lines comprises a data driving line for the odd-numbered column and a data driving line for the even-numbered column; the sources of the pixel units in the odd-numbered column of the first row are respectively connected with the corresponding data driving line for the odd-numbered column, the sources of the pixel units in the even-numbered column of the first row are respectively connected with the corresponding data driving line for the even-numbered column; the sources of the pixel units in the odd-numbered column of the second row are respectively connected with a next data driving line for the even-numbered column adjacent to the data driving line for the corresponding odd-numbered column, and the sources of the pixel units in the even-numbered column of the second row are respectively connected with a next data driving line for the odd-numbered column adjacent to the data driving line for the corresponding even-numbered column;
the operation of driving pixel units of the first row and the pixel units of the second row by the data driving signal, when each data driving signal input by a data driving line being received, comprises:
driving the subpixels in the odd-numbered column of the first row by the data driving line for the odd-numbered column, driving the subpixels in the even-numbered column of the first row by the data driving line for the even-numbered column, driving the subpixels in the odd-numbered column of the second row by the next data driving line for the even-numbered column adjacent to the data driving line for the odd-numbered column, and driving the subpixels in the even-numbered column of the second row by the next data driving line for the odd-numbered column adjacent to the data driving line for the even-numbered column, when each data driving signal input by a data driving line being received.

15. The driving device of claim 12, wherein the operation of driving pixel units of the first row and the pixel units of the second row by the data driving signal, when each data driving signal input by a data driving line being received, comprises:
positively driving the pixel units of the first row and the second row by a first preset voltage, when each data driving signal input by a data driving line being received and the data driving signal is in a first half of a data driving period, wherein the data driving period is a signal period of the data driving signal, and the first preset voltage is greater than a reference voltage; and
negatively driving the pixel units of the first row and the second row by a second preset voltage, when the data driving signal is in a second half of the data driving period, the first preset voltage being smaller than the reference voltage.

16. The driving device of claim 15, wherein the operation of taking a process of having scanned two adjacent rows of the pixel units as a driving period, driving the pixel units in an even-numbered column of a first row by a first scanning driving signal, and driving the pixel units in an even-numbered column of a second row by a second scanning driving signal, when four scanning driving signals respectively input by scanning driving lines in the driving period are received, comprises:
taking a process of having scanned two adjacent rows of the pixel units as a driving period, driving the pixel units in the even-numbered column of the first row by a first scanning driving signal, to turn on the pixel units of the first row for a first pulse duration, when four scanning driving signals respectively input by scanning driving lines in the driving period are received, wherein a starting time and an ending time of the first pulse duration are within the first half of the data driving period; and
driving the pixel units in the even-numbered column of the second row by a second scanning driving signal, to turn on the pixel units of the second row for a second pulse duration, wherein a starting time of the second pulse duration is within the first half of the data driving period while an ending time of the second pulse duration is within the second half of the data driving period.

17. The driving device of claim 12, wherein the pixel unit comprises a first subpixel, a second subpixel and a third subpixel in a row direction, and the three subpixels of each pixel unit are respectively aligned in columns according to an arranging order;
the first subpixel, the second subpixel and the third subpixel respectively correspond to a red subpixel, a green subpixel and a blue subpixel.

18. The driving device of claim 12, wherein polarity of the pixel units between the first row and the second row are opposite.

19. The driving device of claim 18, wherein the pixel units of the first row are inverted in polarity relative to the pixel units of the second row by row inversion.

20. The driving device of claim 12, wherein the pixel units of the first row are pixel units of the odd-numbered row and the pixel units of the second row are pixel units of the even-numbered row; or,
the pixel units of the first row are pixel units of the even-numbered row and the pixel units of the second row are pixel units of the odd-numbered row.
